(19) United States
(12) Patent Application Publication
(10) Pub. No.: US 2026/0251223 A1
(43) Pub. Date: Aug. 27, 2026

(54) GATE VALVE FOR HARSH SERVICE

(71) Applicant: Sayatva, LLC, Cypress, TX (US)

(72) Inventor: Gayathri Srinivasa Ragavan, Cypress, TX (US)

(21) Appl. No.: 19/551,397

(22) Filed: Feb. 26, 2026

Related U.S. Application Data
(60) Provisional application No. 63/764,224, filed on Feb. 27, 2025.

(51) Int. Cl. F16K 3/20; F16K 3/02; F16K 25/04

(52) U.S. Cl. CPC F16K 3/20; F16K 3/0227; F16K 25/04

(57) ABSTRACT

A gate valve for harsh service comprises a valve body having a flow bore, an internal cavity, and annular seats disposed in pockets on each side of a gate. An outer seal and an inner seal are disposed along the interface between each seat and its respective pocket, both oriented to prevent fluid from moving along the interface from the flow bore toward the internal cavity. The outer seal protects the inner seal from abrasive fluid during normal operation, and the inner seal stops leakage if the outer seal becomes worn or damaged, reducing the need for cavity greasing. Each seat includes staggered first and second shoulders at different radial and axial distances for mounting the outer and inner seals, separated by an intermediate shoulder that prevents a single scratch from damaging both sealing surfaces. A wiper restricts particle entry and a seat spring biases the seat against the gate.

### CROSS-REFERENCE TO RELATED APPLICATION AND PRIORITY CLAIM

This application claims the benefit of U.S. Provisional Application No. 63/764,224 filed Feb. 27, 2025, which is hereby incorporated by reference in its entirety.

### TECHNICAL FIELD

The present disclosure relates to gate valves, seat assemblies for gate valves, and sealing components for use in gate valves and seat assemblies therefor. In particular, gate valves suitable for use in fracking operations and other harsh service environments are disclosed.

### BACKGROUND

Gate valves are commonly used, e.g., in oilfield drilling and production, to regulate fluid flow through piping and equipment. They are primarily employed in applications where the desired flow alternates between full, unrestricted passage (valve fully open) and complete shutoff (valve fully closed). When fully closed, a gate valve is also expected to provide isolation by preventing fluid leakage or pressure loss from one side of the valve to the other.

Gate valves are also used for oilfield completion operations including, but not limited to, hydraulic fracturing (fracking). During fracking, a high pressure fluid loaded with proppant materials—such as fine sand or ceramic grains—is pumped down the wellbore. As this abrasive fluid flows moves through the piping and gate valves, the pumping pressure forces it into microscopic gaps at the interfaces between valve gates, seats, stems, and seals. The abrasive particles gradually widen these gaps, allowing further fluid intrusion along the interface and eventually leading to leakage out the opposite end. This propensity for leakage is particularly severe in high pressure-differential areas, such as the interface between a valve seat and a valve body in a gate valve. Once a leak starts, the pressurized flow can accelerate erosion—often referred to as “washout”—which can leave the valve inoperable or unsuitable for use until damaged components are replaced.

It is known to provide flexible seals along the component interfaces in gate valves to restrict leakage of pressurized fluids into other parts of the valve such as the gate cavity or bonnet. In applications where leakage can occur in both directions along a single interface, dual directional seals can be provided on the interface, one configured to restrict upstream leakage and the other configured to restrict downstream leakage. For example, U.S. Pat. No. 12,203,559 B2 entitled “Gate Valve With Single Or Dual Seats And Seat Assemblies For A Gate Valve” describes gate valves provided with directional dual-seal assemblies for the seats.

Despite the use of flexible seals, gate valves used in harsh service such as fracking remain vulnerable to leakage. Pressurized fluid and abrasive particles can erode the sealing surfaces of the seat and body, and cut into rubber, metal, and composite seals. As the seals wear down, small leaks form, allowing high-pressure fracking fluid to enter other parts of the valve like the gate cavity or bonnet. To counteract this, operators often fill the gate cavity with grease, which initially impedes further fluid intrusion. However, over time, the fracking fluid can wash out the grease and resume eroding the valve components. Consequently, operators must frequently refill the valves with grease throughout the fracking operation—an inconvenient, unpleasant, and costly task. A need therefore exists, for a gate valve design that eliminates the need for, or at least reduces the frequency of, greasing the valve during a fracking operation.

### SUMMARY

In one aspect thereof, a gate valve comprises a valve body including a cavity in fluid communication with a flow bore, the flow bore defining a bore axis through the valve body and having a first outer bore portion defined by a first body portion on a first side of the cavity and a second outer bore portion defined by a second body portion on a second side of the cavity. An annular first seat is disposed in a first pocket formed on an inner surface of the first body portion adjacent the cavity, the first seat having a seat bore therethrough forming a first inner bore portion of the flow bore. An annular second seat is disposed in a second pocket formed on an inner surface of the second body portion adjacent the cavity, the second seat having a seat bore therethrough forming a second inner bore portion of the flow bore. A gate is disposed in the cavity between the first seat and the second seat and movable along a stem axis perpendicular to the bore axis between an open gate position and a closed gate position. When the gate is in the open gate position, a gate bore formed therethrough is aligned with the first inner bore portion and the second inner bore portion to allow flow through the valve body, and when the gate is in the closed gate position, the gate bore is not aligned with the first inner bore portion and the second inner bore portion to block flow through the valve body. A first outer seal is disposed along a first interface between the first seat and the first pocket between a first outer pair of opposing faces of the first seat and the first pocket. The first outer pair of opposing faces are oriented parallel to one another at a first orientation relative to the bore axis. The first outer seal is configured to prevent fluid from moving along the first interface in a direction from the flow bore towards the cavity. A first inner seal is disposed along the first interface between a first inner pair of opposing faces of the first seat and the first pocket. The first inner pair of opposing faces are oriented parallel to one another at a second orientation relative to the bore axis. The first inner seal is configured to prevent fluid from moving along the first interface in a direction from the flow bore towards the cavity. The first outer pair of opposing faces includes an outwardly radial face of a first shoulder formed at an axial end of the first seat adjacent the first body portion and a first inwardly radial face of the first pocket.

In another aspect thereof, a gate valve comprises a valve body including a cavity in fluid communication with a flow bore, the flow bore defining a bore axis through the valve body and having a first outer bore portion defined by a first body portion on a first side of the cavity. An annular first seat is disposed in a first pocket formed on an inner surface of the first body portion adjacent the cavity, the first seat having a seat bore therethrough forming a first inner bore portion of the flow bore. A gate is disposed in the cavity adjacent the first seat and movable along a stem axis perpendicular to the bore axis between an open gate position and a closed gate position. When the gate is in the open gate position, a gate bore formed therethrough is aligned with the first inner bore portion to allow flow through the valve body, and when the gate is in the closed gate position, the gate bore is not aligned with the first inner bore portion to block flow through the valve body. A first outer seal is disposed along a first interface between the first seat and the first pocket between a first outer pair of opposing faces of the first seat and the first pocket. The first outer pair of opposing faces are oriented parallel to one another at a first orientation relative to the bore axis. The first outer seal is configured to prevent fluid from moving along the first interface in a direction from the flow bore towards the cavity. A first inner seal is disposed along the first interface between a first inner pair of opposing faces of the first seat and the first pocket. The first inner pair of opposing faces are oriented parallel to one another at a second orientation relative to the bore axis. The first inner seal is configured to prevent fluid from moving along the first interface in a direction from the flow bore towards the cavity. The first outer pair of opposing faces includes an outwardly radial face of a first shoulder formed at an axial end of the first seat adjacent the first body portion and an inwardly radial face of the first pocket.

In yet another aspect thereof, a seat assembly for a gate valve is provided configured for mounting in a pocket on an inner surface of a gate valve body adjacent to an internal cavity. The seat assembly comprises an annular seat having a seat bore formed therethrough defining a bore axis, a first shoulder for mounting an outer seal and a second shoulder for mounting an inner seal. The seat is configured to form, when mounted in the pocket of the gate valve body, an interface between the pocket and the seat assembly extending from the seat bore to an internal cavity. The first shoulder includes a first outwardly radial face disposed at a first radius from the bore axis and extending axially from a first position at a first distance relative to the pocket side of the seat to a first corner disposed at a second distance relative to the pocket side, the second distance being greater than the first distance. The first shoulder further includes a first axial face extending radially outward from the first corner to a second radius from the bore axis, the second radius being greater than the first radius. The second shoulder includes a second outwardly radial face disposed at a third radius from the bore axis and extending axially from a second position at a third distance relative to the pocket side of the seat to a second corner disposed at a fourth distance relative to the pocket side, the fourth distance being greater than the third distance. The second shoulder further includes a second axial face extending radially outward from the second corner to a fourth radius from the bore axis, the fourth radius being greater than the third radius. The outer seal is configured for mounting on the first shoulder when the seat is mounted in the pocket to prevent fluid from flowing along the interface in a direction from the seat bore toward the internal cavity. The inner seal is configured for mounting on the second shoulder when the seat is mounted in the pocket to prevent fluid from flowing along the interface in a direction from the seat bore toward the internal cavity. The annular seat further comprises a third shoulder disposed axially between the first shoulder and the second shoulder. The third shoulder includes a third outwardly radial face disposed at the second radius from the bore axis and extending axially to a third corner, the third corner disposed axially between the first corner and the second corner and a third axial face extending radially outward from the third corner.

### BRIEF DESCRIPTION OF THE DRAWINGS

For a more complete understanding, reference is now made to the following description taken in conjunction with the accompanying Drawings in which:

FIG. 1 is a side view of a gate valve in accordance with one aspect, with the left half of the view illustrating the exterior surface, with the right half of the view cross-sectioned to illustrate internal structure, and with the gate shown in the open position (“open gate position”) to provide an unobstructed flow bore;

FIG. 2 is a full cross-sectional side view of the gate valve with the gate in the open position illustrating a fluid flowing entirely through the flow bore;

FIG. 3 is an enlarged cross-sectional view of a portion of the gate valve denoted in FIG. 2 illustrating the configuration of the body, gate, seats and seals thereof when the gate is in the open position and the fluid is flowing through the flow bore;

FIG. 4 is a cross-sectional side view of the gate valve with the gate in the closed position (“closed gate position”) to block the flow bore so that the fluid cannot flow past the gate;

FIG. 5 is an enlarged cross-sectional view of a portion of the gate valve denoted in FIG. 4 illustrating the configuration of the body, gate, seats and seals thereof when the gate is in the closed position and the fluid cannot flow past the gate;

FIG. 6 is a further enlarged view of a portion of the gate valve denoted in FIG. 5 illustrating additional features of the body, gate, seats and seals thereof; and

FIG. 7 is a cross-sectional view of a seat for a gate valve in accordance with another aspect.

### DETAILED DESCRIPTION

Referring now to the drawings, wherein like reference numbers are used herein to designate like elements throughout, the various views and embodiments of gate valves and seats for a gate valve are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

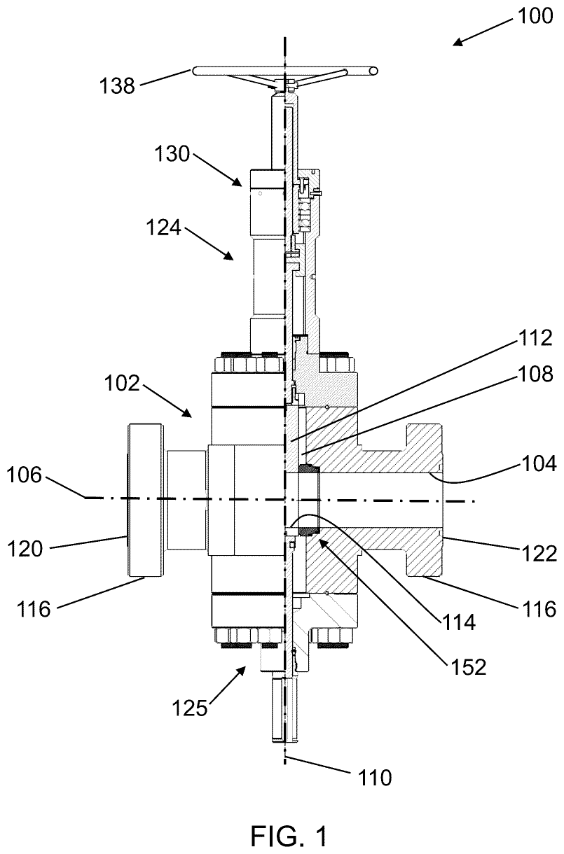

FIGS. 1-6 illustrates a gate valve in accordance with one aspect. The gate valve 100 includes a valve body 102 defining a flow bore 104 formed through the valve body for fluid flow along a bore axis 106. Unless otherwise specified, the terms “axial” and “axially” as used herein describe directions and distances parallel to the bore axis 106, and the terms “radial” and “radially” as used herein describe directions and distances extending perpendicularly towards or from the bore axis (i.e., “radially inward” being a direction or distance extending perpendicularly towards the bore axis, and “radially outward” being a direction or distance extending perpendicularly away from the bore axis).

The valve body 102 further defines an internal cavity 108 extending along a stem axis 110 perpendicular to the bore axis 106. A gate 112 having a gate bore 114 is mounted in the cavity 108 and is movable up and down along the stem axis 110 to selectively enable or block fluid flow through the flow bore 104. The valve body 102 may further define flanges 116 at each end of the flow bore 104 to facilitate connection to other components of the piping system.

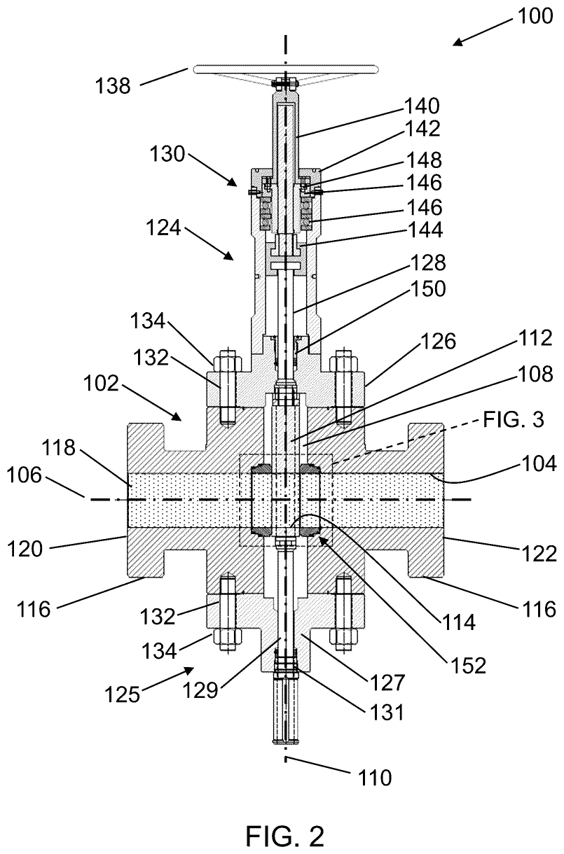

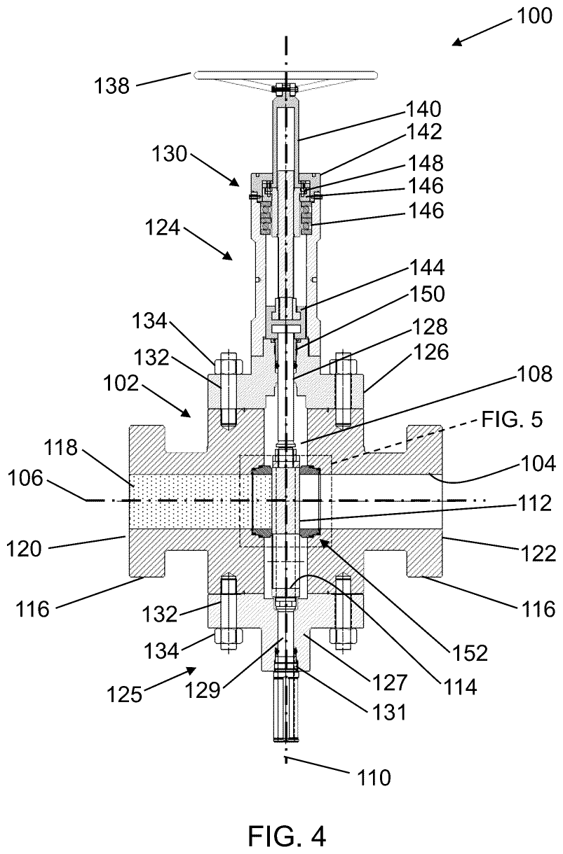

As best seen in FIG. 2, a fluid 118 can flow through the gate valve 100 when the gate 112 is positioned along the stem axis 110 such that at least a portion of the gate bore 114 is aligned with at least a portion of the flow bore 104. This is referred to as the valve being in the “open” position or configuration. The gate valve 100 in the open position allows a fluid 118 to enter the flow bore 104 from an upstream side 120, pass thorough the aligned gate bore 114, and then exit the gate valve from a downstream side 122. As best seen in FIG. 4, the fluid 118 cannot flow through the gate valve 100 when the gate 112 is positioned such that none of the gate bore 114 is aligned with the flow bore 104. This is referred to as the valve being in the “closed” position or configuration. The gate valve 100 in the closed position allows the fluid 118 to enter the flow bore 104 from the upstream side 120, but flow past the gate 112 is blocked.

The gate valve 100 further includes a bonnet assembly 124 attached to the top of the valve body 102. The bonnet assembly 124 includes a bonnet housing 126, an operating stem 128 and a bonnet packing assembly 130. The bonnet housing 126 can serve as an upper cover to the valve body 102. The bonnet housing 126 can be attached to the valve body using removable fasteners, e.g., threaded studs 132 and threaded nuts 134, to provide selective access to the interior of the valve body. A bonnet gasket (not shown) can be used to provide a pressure seal between the valve body 102 and the bonnet housing 126. The operating stem 128 extends within the bonnet housing 126 along the stem axis 110 and is operably attached at an upper end to an external handwheel 138 and threaded nut 140 to move up and down as the handwheel is turned. The operating stem 128 is operably attached at a lower end to the gate 112 for selectively moving the gate up and down within the valve body 102 between the open position and the closed position as the handwheel 138 turns. In alternative embodiments, a powered actuator can be attached to the stem 128 and used to move the gate 112.

The bonnet packing assembly 130 can include a packing housing 142, a stem adapter 144 interfacing between the handwheel 138 and the operating stem 128, support bearings 146, a stem packing gland 148 and stem packing and/or stem seal 150 for sealing between the bonnet housing 126. As previously described, the gate valve 100 is configured so as the handwheel 138 is actuated (or some similar operator is actuated), the operating stem 128 is moved so the gate 112 can either close or open the flow bore 104 in the valve body 102. When the gate 112 is in an open position, fluid 118 is allowed to flow through the flow bore 104 (see FIG. 2) in the valve body 102. When the gate 112 is in a closed position, the flow of fluid 118 is blocked within the flow bore 104 (see FIG. 4).

In some embodiments, the gate valve 100 further includes a body plug assembly 125 attached to the bottom of the valve body 102. The body plug assembly 125 includes a body plug housing 127 and can include a lower stem 129 and a lower stem packing assembly 131. The body plug housing 127 can serve as a lower cover to the valve body 102. The body plug housing 127 can be attached to the valve body 102 using removable fasteners, e.g., threaded studs 132 and threaded nuts 134, to provide selective access to the interior of the valve body. A body plug gasket (not shown) can be used to provide a pressure seal between the valve body 102 and the body plug housing 127. The lower stem 129 can be attached to the lower end of the gate 112 and slidingly supported by the lower stem packing assembly 131 mounted in the body plug housing 127.

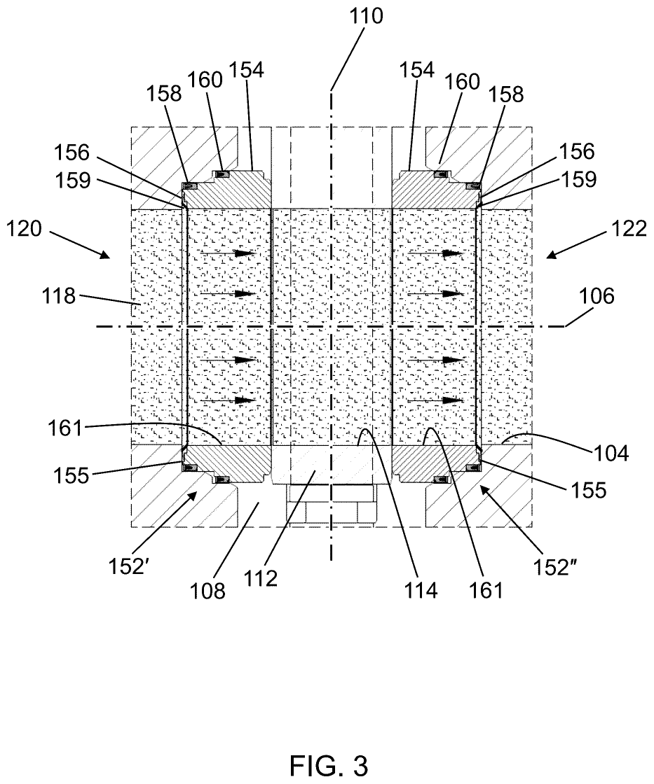

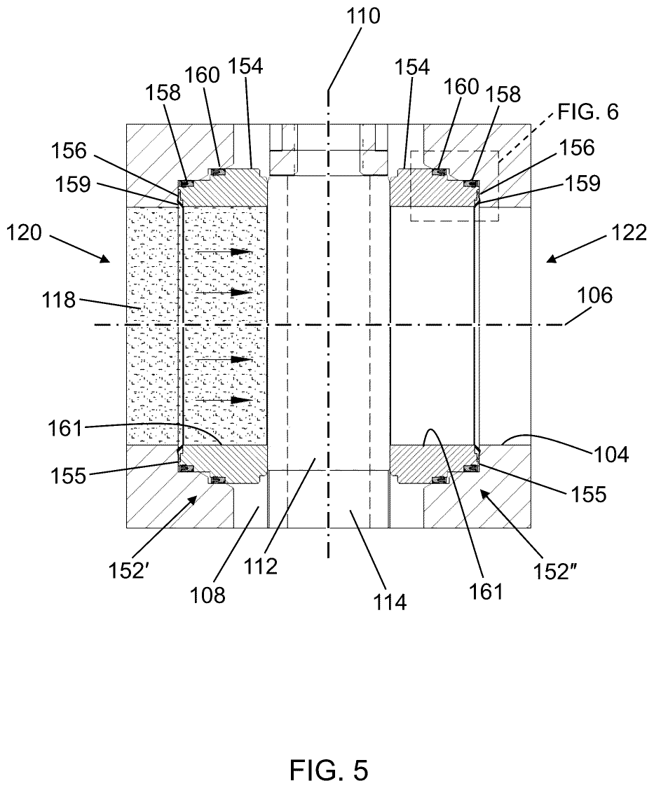

Referring still to FIGS. 1-5, and especially to FIGS. 3 and 5, a seat assembly 152 is provided on each side of the gate 112 between the valve body 102 and the gate to prevent or lessen leakage of high pressure fluid 118 from the upstream portion of the flow bore 104 into the cavity 108 when the gate is closed. The gate valve 100 and the seat assembly 152 are configured to be equally resistant to the leakage of pressurized fluid from the bore 104 into the cavity 108 regardless of which flange 116 is on the upstream (i.e., higher pressure) side of the gate 112. In other words, the gate valve 100 is a bidirectional valve such that either the upstream line or the downstream line can be attached to either side 120, 122 of the valve body 102.

FIGS. 3 and 5 provide enlarged illustrations of the seat assemblies 152 with the gate 112 in the open position and the closed position, respectively. For purposes of description, the upstream side of the valve is denoted 120 and the downstream side is denoted 122, thus the seat assembly denoted 152′ is the upstream assembly and the seat assembly denoted 152″ is the downstream assembly in this example. However, since the gate valve 100 of the illustrated embodiment is bi-directional, the valve would function identically if the pressure and flow direction was reversed.

Each seat assembly 152 includes a seat 154, seat spring 156, an outer seal 158 and an inner seal 160. In some embodiments, the seat assembly 152 further includes a wiper 159. Each seat 154 has an annular shape configured fit within a respective pocket 155 formed in the valve body 102 on either side of the cavity 108 along the bore axis 106. Each seat 154 further defines a seat bore 161 running therethrough that can be aligned with the flow bore 104.

FIG. 3 shows the gate valve 100 in the open position with the gate bore 114 aligned with the seat bores 161 and the flow bore 104 such that pressurized fluid 118 can flow through the gate valve along the bore axis 106 from the upstream side 120 having a higher pressure to the downstream side 122 having a lower pressure. FIG. 5 shows the gate valve 100 in the closed position with the gate bore 114 offset from the flow bore 104 and seat bores 161 such that pressurized fluid 118 from the upstream side 120 cannot flow past the gate 112 along the bore axis 106.

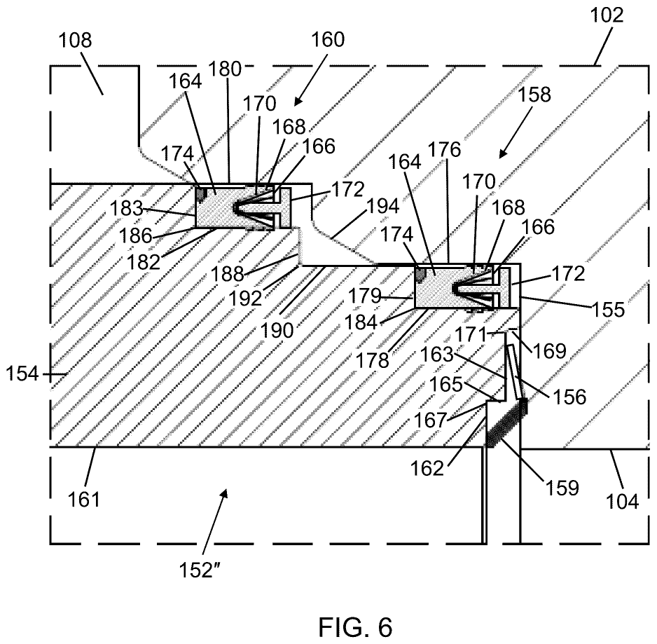

Referring now also to FIG. 6, a portion of the seat assembly 152″ is further enlarged to better illustrate the configuration of the outer seal 158, inner seal 160, seal spring 156 and wiper 159. Although FIG. 6 illustrates the right seat assembly 152″, the left seat assembly 152′ can be substantially identical in construction (though reversed in orientation). Also note that the each of the left and right seat assemblies 152′ and 152″ includes both the outer seal 158 and inner seal 160 for reasons described herein.

The seat wiper 159 is an annular disk ring positioned in a wiper groove 162 formed on the axially-outward facing end of the seat 154 (i.e., the end facing away from the gate 112) and defined by an inwardly-radial surface 165 and the axial surface 162 joined at a wiper corner 167. The seat wiper 159 can be formed of a composite material that is resistant to abrasion. When the seat wiper 159 is compressed between the wiper groove 162 and the seat pocket 155, it restricts the entry of sand and other particles from the bore 104 into the interface between the seat and pocket.

The seat spring 156 is an annular disk spring disposed in spring groove 163 formed on the axially-outward facing end of the seat 154 and defined by an inwardly-radial surface 169 and the axial surface 163 joined at a spring corner 171. In the illustrated embodiment, the spring groove 163 is disposed radially outward from the wiper groove 162. The seat spring 156 can be formed of steel or other metallic materials. When the seat 154 is pushed axially into the seat pocket 155, the seat spring 156 is compressed between the axially-inward facing end of the seat pocket and the axially-outward facing spring groove 163, thus biasing the seat away from the pocket and against the gate 112. This biasing of the seat 154 allows the axially-inward facing ends of the seats to maintain contact with the surfaces of the gate 112 as it moves between the open and closed position.

In preferred embodiments, the outer seal 158 and the inner seal 160 are annular seals of the spring energized type. Each seal 158, 160 includes an annular body 164 having a V-shaped or U-shaped concave surface 166 forming a pair of seal lips 168 extending from the body. The seals 158, 160 may be composed of polymer, elastomeric, non-elastomeric, and/or metallic material or some combination thereof and are configured to be suitable to any application depending on the variability of environmental factors such as flow pressure (low/high) and temperature. A V-shaped seal spring 170 is disposed between the seal lips 168 and stabilized by a hat ring 172. A reinforcing ring 174 can be provided in the body 164 of the seal to prevent extrusion of the material due to high pressures or temperatures.

The seals 158, 160 are mounted on radially-outward facing shoulders of the seat 154. In the illustrated embodiment, the outer seal 158 is mounted on an outer shoulder 178 formed on the seat 154 and defined by an outer axial surface 179 joined to the outer radial surface 178 at an outer seal corner 184. In the illustrated embodiment, the inner seal 160 is mounted on an inner shoulder 182 formed on the seat 154 and defined by an inner axial surface 183 joined to the inner radial surface 182 at an inner seal corner 186. In the illustrated embodiment, the inner shoulder 182 is disposed radially outward from the outer shoulder 178. In the illustrated embodiment, the outer shoulder 178 and the inner shoulder 182 are separated along the surface of the seat 154 by a radially-outward facing intermediate shoulder 190 defined by an intermediate axial surface 188 joined to the intermediate radial surface 190 at an intermediate corner 192.

When the seat 154 carrying the seals 158, 160 is installed in the seat pocket 155 of the valve body 102, the seals are compressed between opposing faces of the seat and the pocket. The outer seal 158 is compressed between the outer shoulder 178 and an opposing radially-inward facing outer pocket face 176, which causes the seal spring 170 to push the seal lips 168 outward against the outer pocket face and outer shoulder to create an outer liquid seal and pressure barrier. The inner seal 160 is similarly compressed between the inner shoulder 182 and an opposing radially-inward facing inner pocket face 180, which causes the seal spring 170 to push the seal lips 168 outward against the inner pocket face and inner shoulder to create an inner liquid seal and pressure barrier.

When pressurized fluid 118 flows from the flow bore 104 into the interface between the seat 154 and the pocket 155, the fluid will first encounter the outer seal 158 and enter the concave surface 166. At the outer seal 158, the pressure from the fluid 118 against the respective concave surface 166 is added to the spring force from the respective seal spring 170 to increasingly press the seal lips 168 of the outer seal against the outer shoulder 178 and outer pocket face 176, thereby increasing the sealing effect to prevent fluid from moving up the interface toward the inner seal 160. However, when the outer seal 158 or associated sealing surfaces 178, 176 become worn or damaged, pressurized fluid can leak past the outer seal and continue moving along the seat/pocket interface until it encounters the inner seal 160. At the inner seal 160, the pressure from the fluid 118 against the respective concave surface 166 is added to the spring force from the respective seal spring 170 to increasingly press the seal lips 168 of the inner seal against the inner shoulder 182 and inner pocket face 180, thereby preventing fluid from moving up the interface toward the internal cavity 108.

In conventional gate valves, it is known to provide two seals on a seat, with the leak resistant-orientation of the two seals being configured in opposite directions, i.e., the outer seal configured to resist pressurized fluid moving along the seat/pocket interface from the flow bore towards the gate cavity (“upstream flow”), and with the inner seal configured to resist pressurized fluid moving along the seat/pocket interface from the gate cavity towards the flow bore (“downstream flow”). However, when such valves are used in harsh services, the outer seal can become worn or damaged, and when pressurized fluid and abrasive particles leak past the outer seal, they will easily pass the inner seal and flow into the interior cavity, because the inner seal has the concave surface and seal lips oriented in the wrong direction to resist flow-bore-to-cavity flow. Thus, even a small leak in the outer seal will allow fluid to flow continuously into the interior cavity, carrying abrasive particles that enlarge the damage to the sealing surfaces and washing away the protective internal grease. This results in the need for frequent greasing and maintenance to avoid failure of the valve.

In contrast to conventional gate valves, the disclosed gate valve 100 requires less maintenance when used in harsh service. The disclosed gate valve 100 provides increased protection against leakage from the flow bore 104 into the internal cavity 108 because the leak-resistant orientation of the inner seal 160 is the same as that of the leak-resistant orientation of the outer seal 158. Thus, during fracking operations and harsh service, the inner seal 160 is initially “protected” from pressurized fluid and abrasive particles by the outer seal 158 so that no little or no wear occurs during normal use. Any small amounts of pressurized liquid that get past the outer seal 158 will be stopped by the inner seal 160 so it cannot enter the internal cavity 108 and wash out the protective grease. When the outer seal 158 becomes worn and develops a small leak, the leakage will stop as soon as the pressurized fluid reaches the inner seal 160, because until now the inner seal has been protected by the outer seal from abrasion and wear. Since the undamaged inner seal 160 stops the flow of pressurized fluid leaking along the interface, this in turn stops the flow of additional abrasive particles through the leak in the outer seal 158, thus minimizing further abrasion damage to the outer seal that would otherwise be caused if the leak was unchecked. In other words, the two seals work cooperatively—the outer seal 158 protects the inner seal 160 until the outer seal begins to leak, at which time the inner seal minimizes the rate of further damage to the outer seal by keeping the leakage flow low. And while the leakage flow rate past the outer seal 158 remains low, the quantity of abrasive particles reaching the inner seal 160 remains low, extending the life of the inner seal so it can continue to protect the grease inside the internal cavity 108 from fluid washout.

Referring still to FIG. 6, in some embodiment, the outer shoulder 178 and the inner shoulder 182 of the seat 154 are separated from one another by at least one axial-facing intervening surface of the seat and one radial-facing intervening surface of the seat. In the illustrated embodiment, the outer shoulder includes radial surface 178 and axial surface 179 joined at corner 184, the inner shoulder includes radial surface 182 and axial surface 183 joined at inner corner 186, and these two shoulders are separated by the intermediate shoulder including an axial-facing intervening surface 188 and a radial-facing intervening surface 190 joined at a intervening corner 192. Unless otherwise specified, the term “intervening surface” as used herein describes a surface that is disposed between two surfaces of the same element, but is not a linear extension of either of the other surfaces. Thus, the axially oriented surface 188 of the intermediate shoulder of the seat 154 is an intervening surface with respect to the radial surface 182 of the inner shoulder and the axial surface 179 of the outer shoulder because it is not a linear extension of either of these seat surfaces (i.e., the three surfaces are separated by corners). Similarly, the radially oriented surface 190 of the intermediate shoulder of the seat 154 is an intervening surface with respect to the radial surface 182 of the second shoulder and the axial surface 179 of the first shoulder because it is not a linear extension of either of these seat surfaces.

The configuration of gate valve 100 having the seat 154 with the outer seat seal surface 178 disposed on an outer shoulder and the inner seal surface 182 disposed on an inner shoulder, wherein the two shoulders are separated by an intervening third shoulder, addresses a problem commonly encountered in conventional gate valves. Since the outer and inner seat seal surfaces 178, 182 of the seat 154 are isolated from one another by the intervening intermediate shoulder 188, 192, 190, a single scratch or gouge on the seat is unlikely to damage both the outer and inner seat seal surfaces.

Referring still to FIG. 6, in some embodiment, the outer radial face 176 of the pocket 155 (i.e., that opposes the outer radial face 178 of the seat's outer shoulder) and the inner radial face 180 of the pocket (i.e., that opposes the inner radial face 182 of the seat's inner shoulder) are separated from one another by at least one intervening surface of the pocket that is not perpendicular to the bore axis 106 and is not parallel to the bore axis. In the illustrated embodiment, the outer radial face 176 and the inner radial face 180 are separated by an intervening angled surface 194 that is neither perpendicular nor parallel to the bore axis 106. The configuration of the pocket 155 having the outer pocket seal surface 176 and the inner pocket seal surface 180 isolated by an intervening angled surface protects against damage to the outer and inner pocket seal surfaces.

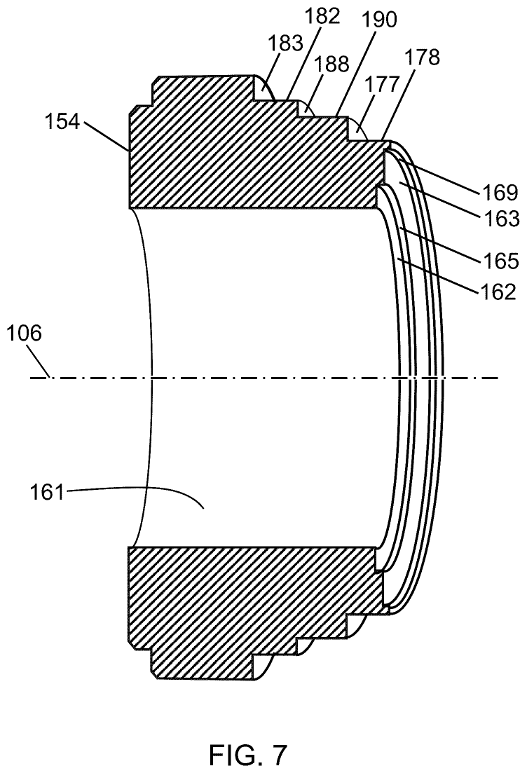

Referring now to FIG. 7, a seat 154 is shown in accordance with another aspect, to better illustrate its annular configuration and the various shoulders and faces of the component.

Although the preferred embodiment has been described in detail, it should be understood that various changes, substitutions and alterations can be made therein without departing from the spirit and scope of the invention as defined by the appended claims.

What is claimed is:

1. A gate valve comprising:
a valve body including a cavity in fluid communication with a flow bore, the flow bore defining a bore axis through the valve body and having a first outer bore portion defined by a first body portion on a first side of the cavity and a second outer bore portion defined by a second body portion on a second side of the cavity;
an annular first seat disposed in a first pocket formed on an inner surface of the first body portion adjacent the cavity, the first seat having a seat bore therethrough forming a first inner bore portion of the flow bore;
an annular second seat disposed in a second pocket formed on an inner surface of the second body portion adjacent the cavity, the second seat having a seat bore therethrough forming a second inner bore portion of the flow bore;
a gate disposed in the cavity between the first seat and the second seat and movable along a stem axis perpendicular to the bore axis between an open gate position and a closed gate position;
wherein, when the gate is in the open gate position, a gate bore formed therethrough is aligned with the first inner bore portion and the second inner bore portion to allow flow through the valve body;
wherein, when the gate is in the closed gate position, the gate bore is not aligned with the first inner bore portion and the second inner bore portion to block flow through the valve body;
a first outer seal disposed along a first interface between the first seat and the first pocket between a first outer pair of opposing faces of the first seat and the first pocket;
wherein the first outer pair of opposing faces are oriented parallel to one another at a first orientation relative to the bore axis; and
wherein the first outer seal is configured to prevent fluid from moving along the first interface in a direction from the flow bore towards the cavity; and
a first inner seal disposed along the first interface between a first inner pair of opposing faces of the first seat and the first pocket;
wherein the first inner pair of opposing faces are oriented parallel to one another at a second orientation relative to the bore axis; and
wherein the first inner seal is configured to prevent fluid from moving along the first interface in a direction from the flow bore towards the cavity; and
wherein the first outer pair of opposing faces includes:
an outwardly radial face of a first shoulder formed at an axial end of the first seat adjacent the first body portion; and
a first inwardly radial face of the first pocket.

2. The gate valve of claim 1, wherein the first outer seal is a spring energized seal including:
a flexible polymeric jacket having a pair of sealing lips extending from a jacket base to form, when viewed in cross section, one of a V-shaped and U-shaped cup, and
a metallic energizing spring disposed in the cup of the jacket between the sealing lips to bias the sealing lips outward relative to one another against the first upstream pair of opposing faces;
wherein the sealing lips are oriented parallel to the bore axis and an opening of the cup between the sealing lips faces axially away from the cavity.

3. The gate valve of claim 2, wherein the first outer seal further comprises a reinforcing ring disposed in the jacket base, whereby extrusion of the jacket material under high pressure or temperature is prevented.

4. The gate valve of claim 2, further comprising a hat ring disposed between the sealing lips, whereby the metallic energizing spring is stabilized.

5. The gate valve of claim 1, wherein the first inner pair of opposing faces includes:
an outwardly radial face of a second shoulder formed on the first seat;
wherein the respective outward radial surfaces of the first shoulder and the second shoulder of the first seat are disposed at different radial distances from the bore axis;
wherein the respective axial surfaces of the first shoulder and the second shoulder of the first seat are disposed at different axial distances from the axial end of the first seat adjacent to the first body portion; and
a second inwardly radial face of the first pocket.

6. The gate valve of claim 5, wherein the first inner seal is a spring energized seal including:
a flexible polymer jacket having a pair of sealing lips extending from a jacket base to form, when viewed in cross section, one of a V-shaped and U-shaped cup, and
a metallic energizing spring disposed in the cup of the jacket between the sealing lips to bias the sealing lips outward relative to one another against the first downstream pair of opposing faces;
wherein the sealing lips are oriented parallel to the bore axis and an opening of the cup between the sealing lips faces axially away from the cavity.

7. The gate valve of claim 5, wherein the first shoulder and the second shoulder of the first seat are separated from one another by at least one axially facing intervening surface of the first seat and one radially facing intervening surface of the first seat.

8. The gate valve of claim 5, wherein the inward radial face of the first pocket and the axial face of the first pocket facing toward the cavity are separated from one another by at least one intervening surface of the first pocket that is not perpendicular to the bore axis and is not parallel to the bore axis.

9. The gate valve of claim 1, further comprising an annular wiper disposed in a wiper groove formed on an axially outward facing end of the first seat, the wiper configured to restrict entry of abrasive particles from the flow bore into the first interface between the first seat and the first pocket.

10. The gate valve of claim 1, further comprising an annular seat spring disposed in a spring groove formed on an axially outward facing end of the first seat, the seat spring configured to bias the first seat axially away from the first pocket and against the gate.

11. The gate valve of claim 1, further comprising a second outer seal and a second inner seal disposed along a second interface between the second seat and the second pocket, the second outer seal and the second inner seal each configured to prevent fluid from moving along the second interface in a direction from the flow bore towards the cavity.

12. A gate valve comprising:
a valve body including a cavity in fluid communication with a flow bore, the flow bore defining a bore axis through the valve body and having a first outer bore portion defined by a first body portion on a first side of the cavity;
an annular first seat disposed in a first pocket formed on an inner surface of the first body portion adjacent the cavity, the first seat having a seat bore therethrough forming a first inner bore portion of the flow bore;
a gate disposed in the cavity adjacent the first seat and movable along a stem axis perpendicular to the bore axis between an open gate position and a closed gate position;
wherein, when the gate is in the open gate position, a gate bore formed therethrough is aligned with the first inner bore portion to allow flow through the valve body;
wherein, when the gate is in the closed gate position, the gate bore is not aligned with the first inner bore portion to block flow through the valve body;
a first outer seal disposed along a first interface between the first seat and the first pocket between a first outer pair of opposing faces of the first seat and the first pocket;
wherein the first outer pair of opposing faces are oriented parallel to one another at a first orientation relative to the bore axis; and
wherein the first outer seal is configured to prevent fluid from moving along the first interface in a direction from the flow bore towards the cavity; and
a first inner seal disposed along the first interface between a first inner pair of opposing faces of the first seat and the first pocket;
wherein the first inner pair of opposing faces are oriented parallel to one another at a second orientation relative to the bore axis; and
wherein the first inner seal is configured to prevent fluid from moving along the first interface in a direction from the flow bore towards the cavity; and
wherein the first outer pair of opposing faces includes:
an outwardly radial face of a first shoulder formed at an axial end of the first seat adjacent the first body portion; and
an inwardly radial face of the first pocket.

13. The gate valve of claim 12, wherein the first inner pair of opposing faces includes:
an outwardly radial face of a second shoulder formed on the first seat;
wherein the respective outward radial surfaces of the first shoulder and the second shoulder of the first seat are disposed at different radial distances from the bore axis;
wherein the respective axial surfaces of the first shoulder and the second shoulder of the first seat are disposed at different axial distances from the axial end of the first seat adjacent to the first body portion; and
a second inwardly radial face of the first pocket.

14. The gate valve of claim 13, wherein the first shoulder and the second shoulder of the first seat are separated from one another by at least one axially facing intervening surface of the first seat and one radially facing intervening surface of the first seat.

15. The gate valve of claim 13, wherein the inward radial face of the first pocket and the axial face of the first pocket facing toward the cavity are separated from one another by at least one intervening surface of the first pocket that is not perpendicular to the bore axis and is not parallel to the bore axis.

16. The gate valve of claim 12, further comprising an annular wiper disposed in a wiper groove formed on an axially outward facing end of the first seat, the wiper composed of a composite material resistant to abrasion.

17. A seat assembly for a gate valve configured for mounting in a pocket on an inner surface of a gate valve body adjacent to an internal cavity, the seat assembly comprising:
an annular seat having a seat bore formed therethrough defining a bore axis, a first shoulder for mounting an outer seal and a second shoulder for mounting an inner seal;
wherein the seat is configured to form, when mounted in the pocket of the gate valve body, an interface between the pocket and the seat assembly extending from the seat bore to an internal cavity;
wherein the first shoulder includes:
a first outwardly radial face disposed at a first radius from the bore axis and extending axially from a first position at a first distance relative to the pocket side of the seat to a first corner disposed at a second distance relative to the pocket side, the second distance being greater than the first distance; and
a first axial face extending radially outward from the first corner to a second radius from the bore axis, the second radius being greater than the first radius;
wherein the second shoulder includes:
a second outwardly radial face disposed at a third radius from the bore axis and extending axially from a second position at a third distance relative to the pocket side of the seat to a second corner disposed at a fourth distance relative to the pocket side, the fourth distance being greater than the third distance; and
a second axial face extending radially outward from the second corner to a fourth radius from the bore axis, the fourth radius being greater than the third radius; and
the outer seal configured for mounting on the first shoulder when the seat is mounted in the pocket to prevent fluid from flowing along the interface in a direction from the seat bore toward the internal cavity; and
the inner seal configured for mounting on the second shoulder when the seat is mounted in the pocket to prevent fluid from flowing along the interface in a direction from the seat bore toward the internal cavity; and
wherein the annular seat further comprises:
a third shoulder disposed axially between the first shoulder and the second shoulder; and
wherein the third shoulder includes:
a third outwardly radial face disposed at the second radius from the bore axis and extending axially to a third corner, the third corner disposed axially between the first corner and the second corner; and
a third axial face extending radially outward from the third corner.

18. The seat assembly of claim 17, wherein the third corner is disposed at the third distance from the pocket side and the third axial face extends radially outward from the third corner to the third radius from the bore axis.

19. The seat assembly of claim 17, further comprising an annular wiper disposed in a wiper groove formed on a pocket side of the seat, the wiper configured to restrict entry of particles from the seat bore into the interface.

20. The seat assembly of claim 17, further comprising an annular seat spring disposed in a spring groove formed on a pocket side of the seat, the seat spring configured to bias the seat axially away from the pocket when the seat is mounted therein.
